(19) United States
(12) Patent Application Publication
(10) Pub. No.: US 2009/0308747 A1
(43) Pub. Date: Dec. 17, 2009

(54) AMMONIA SENSOR

(76) Inventors: Berndt Cramer, Leonberg (DE); Mario Roessler, Ceske Budejovice (CZ); Bernd Schumann, Rutesheim (DE)

Correspondence Address: KENYON & KENYON LLP, ONE BROADWAY, NEW YORK, NY, 10004, US

(21) Appl. No.: 12/294,383

(22) PCT Filed: Jan. 26, 2007
(86) PCT No.: PCT/EP2007/050791

§ 371 Date: Jun. 29, 2009

(30) Foreign Application Priority Data
Mar. 24, 2006 (DE) 102006013698.5

(51) Int. Cl. G01N 27/407; G01N 27/26

(52) U.S. Cl. 204/412; 204/424

(57) ABSTRACT

A gas sensor, particularly an ammonia sensor, having a first sensor cell that is made up of a solid electrolyte, a first measuring electrode that is to be exposed to the measuring gas and a second measuring electrode. In order to reduce an NOₓ cross-sensitivity of the sensor, it is distinguished by the first measuring electrode being covered by a catalytic converter for the chemical conversion of nitrogen oxides.

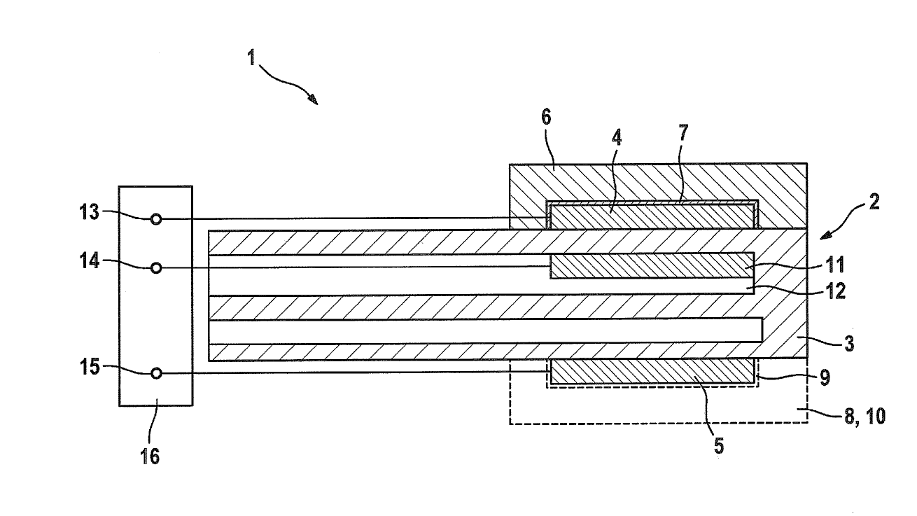

### FIELD OF THE INVENTION

The present invention relates to a gas sensor, especially an ammonia sensor.

### BACKGROUND INFORMATION

In order to reduce pollutant emissions of internal combustion devices, especially internal combustion engines, various influencing controls are known concerning the composition of the exhaust gases issuing forth from them. Among other things, the composition of the exhaust gases is monitored, so that a response may be made available to the setting and adjustment of various operating components and/or operating parameters of the internal combustion device.

Thus, for instance, to reduce the nitrogen emission of internal combustion devices, particularly of Diesel internal combustion engines, their exhaust gas has ammonia NH₃ applied to it for the purpose of the reduction of the nitrogen oxides NOₓ occurring in it. When the ratio is set correctly, NO and NO₂ react almost completely with NH₃ to form H₂O and N₂.

However, the ammonia sensors used to control the so-called “ammonia slip”, that is the overdosing quantity deviating from the optimum, partly have a high NOₓ cross-sensitivity. This also applies to sensors that work according to the mixed potential principle, such as the mixed potential sensor described in DE 40 21 929 A1, which is based on a solid electrolyte whose first surface has the exhaust gas applied to it and whose second surface has a reference gas applied to it, and which includes at least one first electrode that is to be exposed to the exhaust gas and a second electrode to form a sensor cell.

### SUMMARY OF THE INVENTION

The exemplary embodiments and/or exemplary methods of the present invention is therefore based on the object of reducing the NOₓ cross-sensitivity of gas sensors, especially of ammonia sensors.

This object is attained by the features described herein. Advantageous and expedient refinements are made possible by the further features described herein.

Accordingly, the exemplary embodiments and/or exemplary methods of the present invention relates to a gas sensor, particularly an ammonia sensor, having a first sensor cell that is made up of a solid electrolyte, a first measuring electrode to be exposed to the measuring gas and a second measuring electrode. This gas sensor is distinguished by the fact that the first measuring electrode, in the flow direction towards the electrode, is covered by a catalytic converter for the chemical conversion of nitrogen oxides with an additional substance.

The proposal of such a sensor construction is based on the idea that a catalytic converter, that is connected upstream of a measuring electrode in the gas flow direction, assures that, in the presence of NO and NH₃ in the measuring gas that is to be tested, that is, particularly in the exhaust gas of a Diesel engine, in response to the deviation from the optimal mixing ratio of the participating gas components, only the gas component that is present in excess reaches the measuring electrode.

As the catalytic converter, one may use a so-called “SCR” (selective catalytic reduction) catalytic converter. This is catalytically effective with respect to a chemical reaction between nitrogen oxides such as NO, NO₂ and ammonia NH₃.

Since a sensor constructed in this manner reacts with a different sign to NO₂ and NH₃, the signal of a sensor provided with such a catalytic converter is directly a measure for the excess of one of the two gas components NO₂ or NH₃.

Regarded as better materials of such a catalytic converter are titanium dioxide (TiO₂) and/or vanadium pentoxide (V₂O₅), or a mixture of these. Zeolites also have effective properties in this regard.

Furthermore, an electrically insulating layer may be formed between the first measuring electrode and the catalytic converter. It electrically decouples the electrode from the catalytic converter, so that no interfering influences on the measuring signal, that are not in connection with the gas concentration, are able to penetrate from the outside.

For the construction of at least one measuring electrode it is proposed that one use a metal or a metal oxide, for instance, to form a mixed potential electrode. Depending on the type of application, the two electrodes may also be made of identical materials.

Depending on which signals should be recorded additionally, if necessary, using the gas sensor, for example, an oxygen concentration and/or a hydrogen concentration, the second electrode may either also be situated exposed to the measuring gas or also to a reference gas. Depending on the gas component that is of interest, the positioning of a third electrode may also be provided, which is appropriately wired to one or even both the other measuring electrodes.

If the second measuring electrode is also exposed to the measuring gas, it may also additionally be covered by a catalytic converter, and may also have an interposed, electrically insulating layer. Such a sensor may be manufactured very cost-effectively, because of its comparatively simple design. But, based on the use of two catalytic converters, it becomes necessary to produce the two measuring electrodes of different materials or material mixtures, so that, based on the respectively adapted material combinations, given the same gas mixture, a potential difference is able to be created between the two electrodes.

Instead of a reduction catalytic converter, the second measuring electrode could also be covered by an oxidation catalytic converter, however. In the case of a sensor constructed in this manner, at the one electrode, the NOₓ or the NH₃ excess would be measured. By contrast, at the second electrode, the ammonia possibly present will be oxidized to a higher valence by the oxidation catalytic converter connected upstream in the gas flow direction, so that it is not able to supply any signal component.

If a third electrode is positioned, one may also provide a reference air channel, so that, because of appropriate interconnection to one of the two remaining electrodes, for instance, the oxygen content in the measuring gas may be ascertained as an additional sensor signal, based on a known oxygen content in the reference gas. With this, in turn, one is able to take into account or make a correction of a possibly present oxygen cross-sensitivity of the sensor.

The present invention is explained in more detail on the basis of the drawing and the description referring to it below.

### BRIEF DESCRIPTION OF THE DRAWINGS

The FIGURE shows a schematic sectional representation through a gas sensor, particularly an ammonia sensor, in which, according to the present invention, an electrode is covered by a catalytic converter so as to reduce the NOₓ cross-sensitivity.

### DETAILED DESCRIPTION

Going into detail, gas sensor 1 includes a first sensor cell 2, which is made up of a solid electrolyte 3, a first measuring electrode 4 that is to be exposed to a measuring gas and a second measuring electrode 5. In order to reduce the NOₓ cross-sensitivity of the signals recorded using this sensor, first measuring electrode 4 is covered by a catalytic converter 6. This catalytic converter 6 is catalytically effective at least with respect to a chemical reaction between the nitrogen oxides and ammonia. Thus, when there is an imbalance between nitrogen oxides (NOₓ) and ammonia (NH₃) in the measuring gas, only the gas component that is present in excess is able to reach the measuring electrode and thereby bring about a signal change, because of the selective catalytic reaction of these gas components.

Based on the different signs of the signal change caused by an excess of NOₓ or NH₃, an unambivalent allocation is possible to the gas component that is present in excess. The appropriately parameterized amplitude of the signal or the signal change is thereby able to be evaluated as control parameter, for instance, for setting a so-called “ammonia slip” for the treatment of Diesel exhaust gas, by admixing urea-water solution to the exhaust gas of a Diesel internal combustion engine.

In response to an optimally adjusted admixture of ammonia to the Diesel exhaust gas, the nitrogen oxides present in the exhaust gas are converted to nitrogen and water almost free of residues, by the selective catalytic reaction (SCR) with ammonia. The gas sensor, which may be particularly designed as an ammonia sensor, then supplies a constant signal. Signal interferences, which would corrupt the sensor signal, particularly based on a reduction of nitrogen oxides by ammonia proportions, also present in the measuring gas, that has not yet taken place, are prevented, according to the present invention, by the catalytic converter situated upstream of measuring electrode 4 in the gas flow direction.

As the catalyst materials, titanium dioxide with vanadium pentoxide come into consideration, but zeolites are also superbly suitable for such applications.

To avoid other interfering influences which, for example, could have an effect on measuring electrode 4 by catalytic reactions in catalytic converter 6, an electrically insulating layer 7 is developed between these two sensor components 4, 6. In order to maintain permeability to gas all the way to the measuring electrode, this may be designed to be porous.

The construction of measuring electrodes 4, 5 may be performed in the form of a so-called “mixed potential electrode”, for example, and this may be based on metal and/or metal oxide. Platinum (Pt), platinum-gold combinations (Pt—Au), or the like are particularly suitable for this purpose.

Second measuring electrode 5 is also exposed to the measuring gas, in this instance, and may be made of the same material as first measuring electrode 4. If this second measuring electrode 5 is also covered by a catalytic converter 8, a material composition that deviates from that of first measuring electrode 4 has to be provided, however. This takes into account that essentially the same gas composition with respect to the ammonia NH₃ content and the nitrogen oxide NOₓ proportion prevails at both electrodes 4, 5. That is why the selection of different material components for the two measuring electrodes 4, 5 represents a possibility of parameterizing the sensor, namely, based on known electrochemical reactions of gases at the 3-phase boundary of a solid electrolyte gas sensor.

In one specific embodiment modified from this, instead of reduction catalytic converter 8, for instance, an oxidation catalytic converter 10 may be provided. In such a design, the ammonia excess or a non-reduced nitrogen oxide proportion in the measuring gas is measured at first measuring electrode 4. At second measuring electrode 5, that is covered by oxidation catalytic converter 10, ammonia that may possibly be present in the measuring gas is simply oxidized to a higher valence. Then, depending on the NOₓ cross-sensitivity of second measuring electrode 5 that is covered by oxidation catalytic converter 10, sensor 1 just measures the pure ammonia excess.

For the sake of completeness, we should note that catalytic converter 8 is also separated from second measuring electrode 5 by an electrically insulating layer 7, corresponding to the positioning with respect to catalytic converter 6. The same may apply for oxidation catalytic converter 10.

In order to broaden the specific embodiments of a gas sensor 1 described up to this point, so as to have the possibility of ascertaining the oxygen concentration in the measuring gas, in this schematic illustration we show, in exemplary fashion, still a third electrode 11 in an air reference channel 12. The interconnection of the individual electrodes 4, 5, 11 may be made via terminals 13, 14, 15 in a control unit 16 that is appropriately developed.

In one further modified specific embodiment, one may also do without the development of second measuring electrode 5. In that case, gas sensor 1 is a simple 2-electrode sensor having a mixed potential electrode on the exhaust gas side and an electrode in an air reference channel which, according to the exemplary embodiments and/or exemplary methods of the present invention, has an at least greatly reduced, if not almost completely eliminated NOₓ cross-sensitivity.

1-10. (canceled)

11. A gas sensor, comprising:
a first measuring electrode, which is to be exposed to a measuring gas;
a second measuring electrode; and
a first sensor cell including a solid electrolyte;
wherein the first measuring electrode is covered by a catalytic converter for chemically converting nitrogen oxides.

12. The gas sensor of claim 11, wherein the catalytic converter is catalytically effective with respect to a chemical reaction between nitrogen oxides, including at least one of NO, NO₂ and ammonia (NH₃).

13. The gas sensor of claim 11, wherein the catalytic converter has components of at least one of titanium dioxide (TiO₂) and vanadium pentoxide (V₂O₅).

14. The gas sensor of claim 11, wherein the catalytic converter has components of zeolite.

15. The gas sensor of claim 11, wherein an electrically insulating layer is developed between the first measuring electrode and the catalytic converter.

16. The gas sensor of claim 11, wherein the measuring electrode is constructed of at least one of a metal and a metal oxide.

17. The gas sensor of claim 11, wherein the second measuring electrode is situated so that it is exposed to the measuring gas.

18. The gas sensor of claim 11, wherein the second measuring electrode is covered by a catalytic converter.

19. The gas sensor of claim 11, wherein the second measuring electrode is covered by an oxidation catalytic converter.

20. The gas sensor of claim 11, further comprising:
a third electrode provided in a reference air channel.
